(19) United States
(12) Patent Application Publication
(10) Pub. No.: US 2007/0139368 A1
(43) Pub. Date: Jun. 21, 2007

(54) Display device capable of quickly switching signal sources and the method thereof

(75) Inventor: Shih-Hua Tseng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/370,922

(22) Filed: Mar. 9, 2006

(30) Foreign Application Priority Data
Dec. 15, 2005 (TW) 094144496

(51) Int. Cl. G09G 5/00

(52) U.S. Cl. 345/156

(57) ABSTRACT

A display device capable of quickly switching signal sources, including a connection interface and an input interface. The connection interface electrically connects a plurality of signal sets. The input interface has a plurality of signal set selection keys corresponding to the signal sets respectively to thereby select a signal source. A first predetermined signal source of a respective signal set that has the video signal is automatically selected when a signal set selection key of the input interface is pressed. A subsequent predetermined signal source of the respective signal set that has the video signal is automatically selected when the signal set selection key of the input interface is pressed again. Accordingly, the invention can reduce the time required for signal source selection by a simple operation interface to thereby eliminate inconvenience in use to a user.

### BACKGROUND OF THE INVENTION

1. Field of the Invention

The invention relates to a display device and, more particularly, to a display device capable of quickly switching signal sources and the method thereof.

2. Description of Related Art

A typical display device has multiple sets of fixed input signal sources for a user to select signals such as RGB D-sub, RGB, DVI, YPbPr 1, YPbPr 2, SV, AV, UHF/VHF, and the like.

FIG. 1 is a schematic diagram of a selection of signal sources of a typical display device. As shown in FIG. 1, when the user desires to change an input signal, a selection key on a remote control of the display device is pressed to thus sequentially select the signal sources. For example, a sequence of HDMI, RGB D-sub, YPbPr 1, YPbPr 2 and the like is sequentially selected, and finally the selection goes back to HDMI. Such a selection requires pressing the selection key on the remote control every time for changing the signal source selected, which wastes the time in operation for selection, increases the selection time with the additional signal sources, and cannot define and expand new signal sources by the user.

FIG. 2 is a schematic diagram of another selection of signal sources of a typical display device. In FIG. 2, an On-Screen Display (OSD) menu is displayed on a screen to accordingly switch the signal sources. For example, a source submenu is selected from a main menu, and subsequently a direction key is used in the source submenu to select an input signal (HDMI, RGB D-sub, and the like). Such a selection has a complicated operation interface, which causes an inconvenience in use.

Therefore, it is desirable to provide an improved selection method to mitigate and/or obviate the aforementioned problems.

### SUMMARY OF THE INVENTION

An object of the invention is to provide a display device capable of quickly switching signal sources and the method thereof, which can reduce the time required for signal source selection by a simple operation interface to thereby eliminate inconvenience in use.

Another object of the invention is to provide a display device capable of quickly switching signal sources and the method thereof, which can provide a user the capability to define a signal source to thereby increase the expansibility of the display device.

To achieve the objects, a display device capable of quickly switching signal sources is provided. The display device includes a connection interface and an input interface. The connection interface electrically connects a plurality of signal sets, each signal set having one or more predetermined signal sources to thus provide a video signal to the display device for display. The input interface is implemented with a plurality of signal set selection keys corresponding to the signal sets respectively to thereby select a signal source.

Pressing a signal set selection key of the input interface automatically selects a first predetermined signal source of a respective signal set that has the video signal, and re-pressing the signal set selection key of the input interface automatically selects a subsequent predetermined signal source of the respective signal set that has the video signal.

When all signal sources of the respective signal set corresponding to the signal set selection key of the input interface that have been pressed do not have the video signal, the display device displays a blue screen.

Alternatively, when all signal sources of the respective signal set corresponding to the signal set selection key of the input interface that have been pressed do not have the video signal, the display device enters a power saving screen.

In addition, the input interface includes a remote control or is internally implemented in a panel of the display device. Further, a method of quickly switching signal sources is provided, which is used in a display device including a connection interface and an input interface, wherein the connection interface electrically connects a plurality of signal sets, each signal set having one or more predetermined signal sources, and the input interface is implemented with a plurality of signal set selection keys corresponding to the signal sets respectively to thereby select a signal source. The method comprises the steps: (A) pressing a signal set selection key of the input interface to select a signal source of a signal set corresponding to the signal set selection key of the input interface; (B) displaying the signal source on the display device; and (C) pressing the signal set selection key of the input interface to automatically select another signal source of the signal set.

Pressing a signal set selection key of the input interface in step (A) automatically selects a first predetermined signal source of the signal set that has an input video signal, and pressing again the signal set selection key of the input interface in step (C) automatically selects a subsequent predetermined signal source of the signal set that has the input video signal.

The method further comprises a step: (D) displaying a blue screen when the signal set selection key of the input interface has been pressed and none of the signal sources of the signal set has the input video signal.

Alternatively, the method further comprises a step: (E) entering a power saving screen when the signal set selection key of the input interface has been pressed and none of the signal sources of the signal set has the input video signal.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a selection of signal sources of a typical display device;

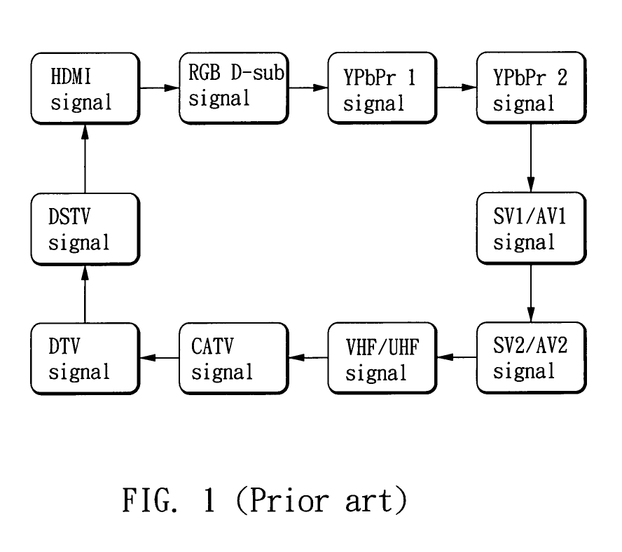

FIG. 2 is a schematic diagram of another selection of signal sources of a typical display device;

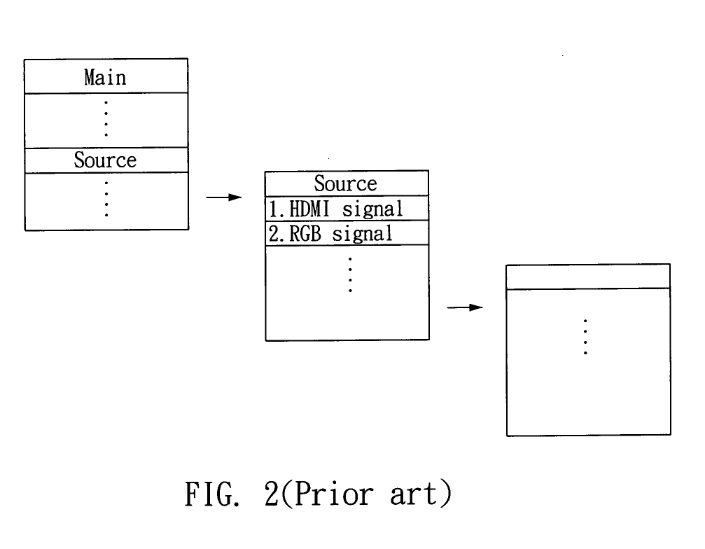

FIG. 3 is a schematic diagram of a selection of signal sources of a display device according to an embodiment of the invention;

FIG. 4 is a schematic view of an input interface of a display device according to an embodiment of the invention;

FIG. 5 is a perspective view of a display device according to an embodiment of the invention;

FIG. 6 is a schematic view of a display device according to another embodiment of the invention; and

FIG. 7 is a schematic view of a display device according to a further embodiment of the invention.

### DETAILED DESCRIPTION OF THE PREFERRED EMBODIMENT

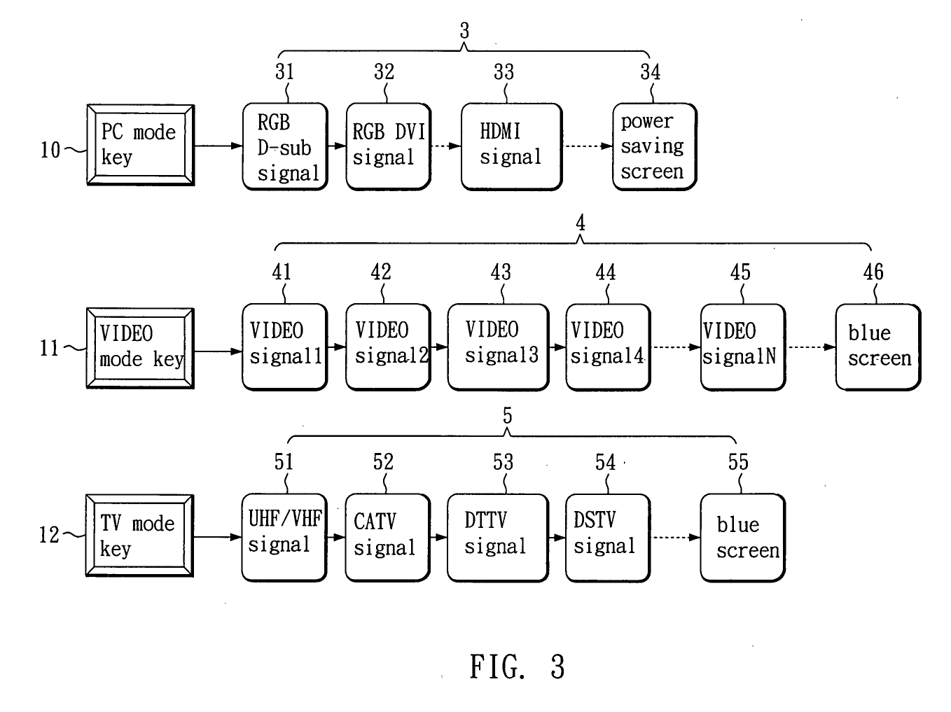

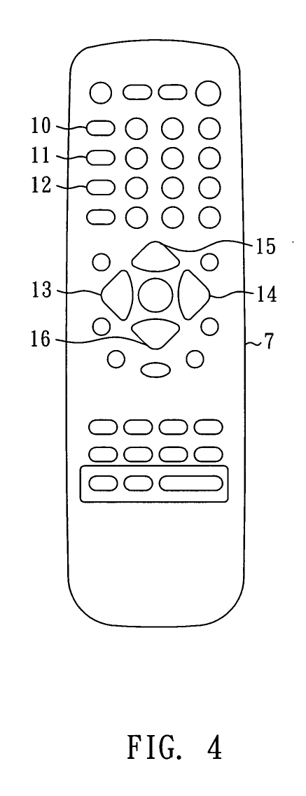

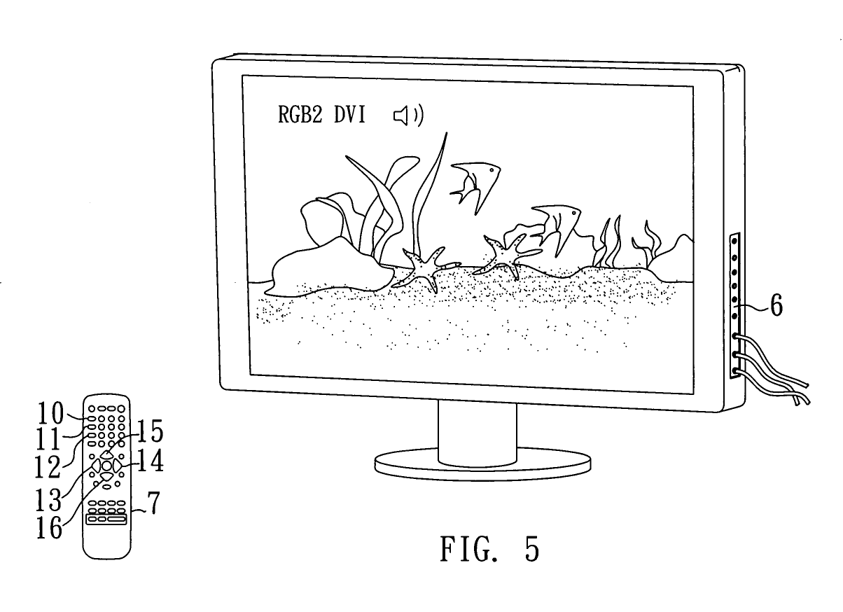

FIG. 3 is a schematic diagram of a selection of signal sources of a display device 1 according to an embodiment of the invention. FIG. 4 is a schematic view of an input interface of the display device 1. FIG. 5 is a perspective view of the display device 1. The display device 1 includes a connection interface 6 and an input interface 7.

In this embodiment, the connection interface 6 electrically connects a plurality of signal sets 3-5, each signal set having one or more predetermined signal sources to thus provide a video signal to the display device 1 for display.

In FIG. 4, the input interface 7 is implemented with multiple signal set selection keys 10-12 and four direction keys 13-16. The signal set selection keys 10-12 correspond to the signal sets 3-5 in a one-to-one manner and are used to select a signal source. The signal set selection keys 10-12 are a personal computer mode key 10 (PC mode key), a video mode key 11 (VIDEO mode key) and a television mode key 12 (TV mode key). The four direction keys 13-16 are used to select an operating image.

Accordingly, pressing a signal set selection key 10, 11 or 12 of the input interface 7 automatically selects a first predetermined signal source of a respective signal set 3, 4 or 5 that has the video signal, and pressing again the signal set selection key 10, 11 or 12 of the input interface 7 automatically selects a subsequent predetermined signal source of the respective signal set 3, 4 or 5 that has the video signal.

For example, when a user presses the TV mode key 12, the first predetermined signal source, i.e., the wireless television signal 51 (UHF/VHF) of FIG. 3, of the signal set 5 is automatically selected. If the first predetermined signal source does not have the video signal, a subsequent predetermined signal source, i.e., the cable television signal 52 (CATV), is automatically selected. If the cable television signal 52 has the video signal, the display device 1 displays the video signal. When the user presses again the TV mode key 12, a subsequent predetermined signal source that has the video signal is automatically selected. For example, if the digital terrestrial television signal 53 (DTTV) has no signal, the digital satellite television signal 54 (DSTV) is further determined to have the video signal or not. If none of the signal set 5 corresponding to the TV mode key 12 has the video signal, a blue screen is presented.

The PC mode key 10 has a similar operation. If the user presses the PC mode key 10 and none of the signal sources of the signal set 3 corresponding to the PC mode key 10 has the video signal, a power saving screen is entered.

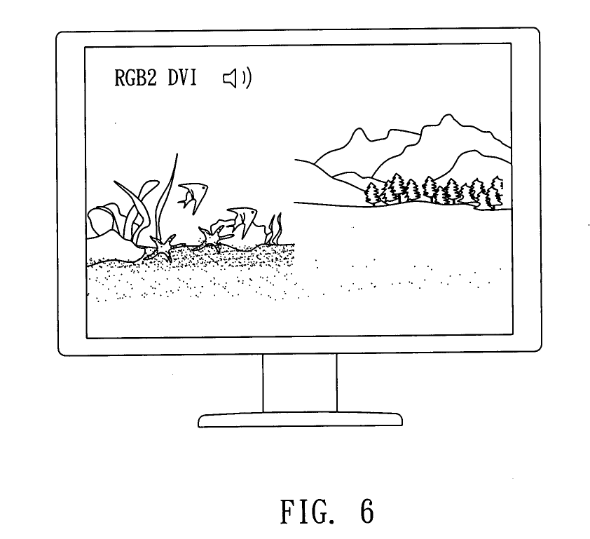

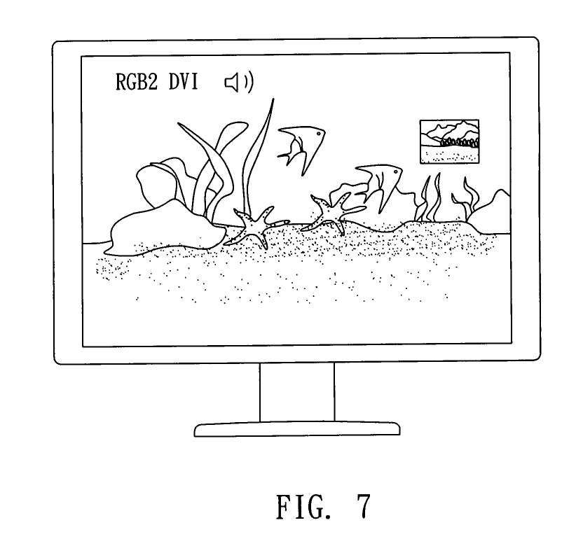

FIG. 6 is a schematic view of a display device according to another embodiment of the invention. FIG. 7 is a schematic view of a display device according to a further embodiment of the invention. Referring to FIGS. 5 to 7, the operation is similar except for a display frame on the display device 1. The display frame is a full-screen display in FIG. 5, a left and right picture-on-picture (POP) mode in FIG. 6, and a picture-in-picture (PIP) mode in FIG. 7. As shown in FIG. 6, the left image has a trumpet icon (or another icon to indicate a working symbol). When the user presses the right key 14 (one of the direction keys), the trumpet icon moves to the right side to thereby indicate that the user has selected to operate in the right image. As shown in FIG. 7, the main image has a trumpet icon (or another icon to indicate a working symbol). When the user presses a direction key 16, the trumpet icon moves to the lower side to thereby indicate that the user has selected to operate in the auxiliary image.

In addition, the user can re-define the signal set selection keys 10-12 corresponding to the signal sets 3-5. For example, a new video signal 45 (VIDEO N) can be added in the VIDEO mode key 11. The user can also change the sequence of the signal sources. For example, when the TV mode key 12 has been pressed, the CATV signal 52 is first detected and the UHF/VHF signal 51, the DTTV signal 53 and the DSTV signal 54 are detected sequentially.

In view of the foregoing, it is known that the invention can reduce the time required for signal source selection by a simple operation interface to thereby eliminate inconvenience in use to a user. In addition, the user can re-define the signal sources to thereby increase the expansibility of the display device.

Although the present invention has been explained in relation to its preferred embodiment, it is to be understood that many other possible modifications and variations can be made without departing from the spirit and scope of the invention as hereinafter claimed.

What is claimed is:

1. A display device capable of quickly switching signal sources, comprising:
a connection interface, which electrically connects a plurality of signal sets, each signal set having one or more predetermined signal sources to thus provide a video signal to the display device for display; and
an input interface, which is implemented with a plurality of signal set selection keys corresponding to the signal sets respectively to thereby select a signal source of a respective signal set;
wherein the signal source of the respective signal set is automatically selected when a signal set selection key of the input interface corresponding to the signal source of the respective signal set is pressed, and another predetermined signal source of the respective signal set is automatically selected when the signal set selection key of the input interface is pressed again.

2. The display device as claimed in claim 1, wherein a first predetermined signal source of a signal set that has the video signal is automatically selected when a signal set selection key of the input interface corresponding to the signal set is pressed, and a subsequent predetermined signal source of the signal set that has the video signal is automatically selected when the signal set selection key of the input interface is pressed again.

3. The display device as claimed in claim 2, wherein a blue screen is presented when none of the signal sources of the signal set corresponding to the signal set selection key of the input interface has the video signal.

4. The display device as claimed in claim 2, wherein a power saving screen is entered when none of the signal sources of the signal set corresponding to the signal set selection key of the input interface has the video signal.

5. The display device as claimed in claim 1, wherein the display device comprises a left picture-on-mode and a right picture-on-picture mode.

6. The display device as claimed in claim 1, wherein the display device comprises a picture-in-picture mode.

7. The display device as claimed in claim 5 or 6, wherein the input interface comprises four direction keys to select an operating image.

8. The display device as claimed in claim 1, wherein the input interface comprises a remote control.

9. A method of quickly switching signal sources, which is used in a display device including a connection interface and an input interface, wherein the connection interface electrically connects a plurality of signal sets, each signal set having one or more predetermined signal sources, and the input interface is implemented with a plurality of signal set selection keys corresponding to the signal sets respectively to thereby select a signal source, the method comprising the steps:
(A) pressing a signal set selection key of the input interface to select a signal source of a signal set corresponding to the signal set selection key of the input interface;
(B) displaying the signal source on the display device; and
(C) pressing the signal set selection key of the input interface to automatically select another signal source of the signal set.

10. The method as claimed in claim 9, wherein pressing a signal set selection key of the input interface in step (A) automatically selects a first predetermined signal source of the signal set that has an input video signal, and pressing again the signal set selection key of the input interface in step (C) automatically selects a subsequent predetermined signal source of the signal set that has the input video signal.

11. The method as claimed in claim 9, further comprising a step:
(D) displaying a blue screen when the signal set selection key of the input interface is pressed and none of the signal sources of the signal set has the input video signal.

12. The method as claimed in claim 9, further comprising a step:
(E) entering a power saving screen when the signal set selection key of the input interface is pressed and none of the signal sources of the signal set has the input video signal.
